(19) United States
(12) Patent Application Publication
(10) Pub. No.: US 2013/0115490 A1
(43) Pub. Date: May 9, 2013

(54) RECHARGEABLE BATTERY

(71) Applicants: Joong-Heon Kim, Yongin-si (KR); Chi-Young Lee, Yongin-si (KR); Jong-Seok Moon, Yongin-si (KR); Jeong-Wan Haam, Yongin-si (KR)

(72) Inventors: Joong-Heon Kim, Yongin-si (KR); Chi-Young Lee, Yongin-si (KR); Jong-Seok Moon, Yongin-si (KR); Jeong-Wan Haam, Yongin-si (KR)

(21) Appl. No.: 13/620,504

(22) Filed: Sep. 14, 2012

(30) Foreign Application Priority Data
Nov. 4, 2011 (KR) 10-2011-0114623

(51) Int. Cl. H01M 2/06; H01M 10/04; H01M 2/36

(52) U.S. Cl. 429/82; 429/179; 29/623.2

(57) ABSTRACT

A rechargeable battery according to an exemplary embodiment of the present invention includes an electrode assembly having a positive electrode and a negative electrode, a case for housing the electrode assembly, and a terminal electrically coupled to the electrode assembly and protruding to an outside of the case. An internal pressure of the case is lower than an atmospheric pressure.

### CROSS-REFERENCE TO RELATED APPLICATION

This application claims priority to and the benefit of Korean Patent Application No. 10-2011-0114623 filed in the Korean Intellectual Property Office on Nov. 4, 2011, the entire contents of which are incorporated herein by reference.

### BACKGROUND

1. Field

The described technology relates generally to a rechargeable battery and a battery module.

2. Description of Related Art

Unlike a primary battery that is not designed to be recharged, a rechargeable battery can be repeatedly charged and discharged. A small-capacity rechargeable battery has been used for a small electronic device such as a mobile phone, a laptop computer, and a camcorder, and a large-capacity rechargeable battery has been used as a power source for driving a motor of a hybrid electric vehicle or an electric vehicle.

Lately, a high power rechargeable battery has been introduced. The high power rechargeable battery may use a high energy density non-aqueous electrolyte. The high power rechargeable battery includes a plurality of rechargeable batteries coupled in series. Such a high power rechargeable battery has been used for an apparatus requiring high power, for example, for driving a motor of a hybrid electric vehicle or an electric vehicle.

Furthermore, one large capacity rechargeable battery may be formed of a plurality of rechargeable batteries coupled in series. The rechargeable battery may be formed in a cylindrical shape or a rectangular shape (e.g., a square shape).

The rechargeable battery includes an electrode assembly having a positive electrode and a negative electrode. When a gap between the positive electrode and the negative electrode is wide, a migration distance of ions becomes longer. Accordingly, the efficiency of charge and discharge may become deteriorated.

At an initial stage, a predetermined pressure is applied in order to closely arrange rechargeable batteries. When the predetermined pressure is applied, an internal pressure of a rechargeable battery is also increased. As a result, a cycle-life of a rechargeable battery may be deteriorated.

The above information disclosed in this Background section is only for enhancement of understanding of the background of the described technology and therefore it may contain information that does not form the prior art that is already known in this country to a person of ordinary skill in the art.

### SUMMARY

The described technology has been made in an effort to provide a rechargeable battery having features of improving efficiency of charging and discharging.

An exemplary embodiment provides a rechargeable battery. The rechargeable battery includes an electrode assembly including a positive electrode and a negative electrode, a case housing the electrode assembly, and a terminal electrically coupled to the electrode assembly and protruding to an outside of the case. An internal pressure of the case may be lower than an atmospheric pressure.

A difference between the internal pressure of the case and the atmospheric pressure may be greater than about 45 kPa. The electrode assembly may have a curved outer surface, and the curved outer surface may be concave toward an inside of the electrode assembly in a thickness direction of the electrode assembly.

A distance between the positive electrode and the negative electrode at a center part in a height direction of the electrode assembly may be less than distances between the positive electrode and the negative electrode at both ends in the height direction of the electrode assembly. A distance between the positive electrode and the negative electrode may gradually decrease as a center part of the electrode assembly is approached from the both ends in the height direction of the electrode assembly.

An outer side of the electrode assembly at a center part in a height direction of the electrode assembly may be separated from a tangent line in the height direction from a surface near a top end of the electrode assembly to a surface near a bottom end of the electrode assembly, and may be disposed toward the center of the electrode assembly. A distance from the outer side of the electrode assembly to the tangent line may gradually increase as a center is approached in the height direction from the top end and the bottom end.

The sealing cap may include a column member in an electrolyte injection opening and a flange member at a top end of the column member and in a first groove on the electrolyte injection opening.

A second groove may be on the first groove, the second groove may be wider than the first groove, a sealing cover may be in the second groove, and the sealing cover may be fixed at a cap plate through welding.

Another embodiment provides a method for manufacturing a rechargeable battery. The method includes injecting an electrolyte solution into a case that houses an electrode assembly through an electrolyte injection opening in a cap plate coupled to the case, disposing a sealing cap at the electrolyte injection opening, forming a negative pressure inside the case by discharging gas from the case through the electrolyte injection opening using a negative pressure forming member that is disposed at the cap plate, and inserting the sealing cap in the electrolyte injection opening and installing the sealing cap at the electrolyte injection opening by pressing the sealing cap using the negative pressure forming member after the negative pressure forming member is coupled to the cap plate.

In the forming the negative pressure, a difference between an internal pressure of the case and an atmospheric pressure may be greater than about 45 kPa. In the forming the negative pressure, the negative pressure forming member may be pipe-shaped and may surround a periphery of the electrolyte injection opening from an outer side of the electrolyte injection opening, and gas may be discharged from the case.

According to an exemplary embodiment, a negative pressure is formed inside the case. Accordingly, a gap between the positive electrode and the negative electrode may be reduced, thereby improving charging and discharging efficiency.

### BRIEF DESCRIPTION OF THE DRAWINGS

FIG. 1 is a perspective view that illustrates a rechargeable battery in accordance with a first exemplary embodiment of the present invention.

FIG. 2 is a cross-sectional view of FIG. 1 taken along the line II-II .

FIG. 3 is a cross-sectional view of FIG. 1, taken along the line III-III.

FIG. 4A illustrates forming a negative pressure inside a case, and FIG. 4B illustrates installing a sealing cap at an electrolyte injection opening.

FIG. 5 is a graph showing changes in a thickness of an electrode assembly according to an internal pressure of a case.

FIG. 6 is a graph that compares charging and discharging amounts between a typical rechargeable battery and a rechargeable battery according to the first exemplary embodiment of the present invention.

FIG. 7A is a photograph illustrating an inside of a typical rechargeable battery, and FIG. 7B is a photograph illustrating an inside of a rechargeable battery in accordance with the present exemplary embodiment.

FIG. 8 is a graph that shows a pressure applied to a rectangular rechargeable battery.

FIG. 9A illustrates forming a negative pressure inside a case of a rechargeable battery in accordance with a second exemplary embodiment of the present invention.

FIG. 9B illustrates disposing a sealing cap at an electrolyte injection opening of a rechargeable battery in accordance with the second exemplary embodiment of the present invention.

FIG. 9C illustrates a sealing cover disposed at the electrolyte injection opening of a rechargeable battery in accordance with the second exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Like reference numerals designate like elements throughout the specification.

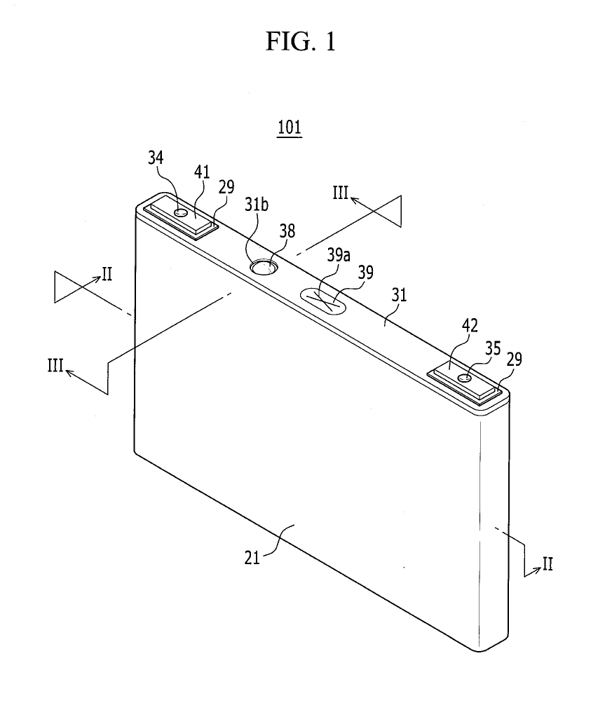

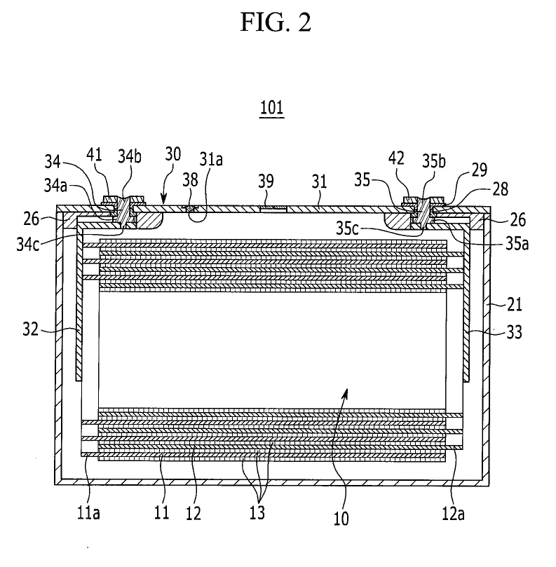

FIG. 1 is a perspective view that illustrates a rechargeable battery in accordance with a first exemplary embodiment of the present invention, and FIG. 2 is a cross-sectional view of FIG. 1 taken along the line II-II .

Referring to FIG. 1 and FIG. 2, a rechargeable battery 101 in accordance with the first exemplary embodiment may include an electrode assembly 10, a case 21 internally housing the electrode assembly 10, and a cap assembly 30 coupled at an opening of the case 21. The electrode assembly 10 may include a positive electrode 11 and a negative electrode 12, which are spiral wound with a separator 13 therebetween.

For example, the rechargeable battery 101 in accordance with the first exemplary embodiment may be a lithium ion secondary battery formed in a rectangular shape. However, the present invention is not limited thereto. Embodiments of the present invention may be applied to various batteries such as a lithium polymer battery and a cylindrical battery.

The positive electrode 11 and the negative electrode 12 may include an uncoated region 11a and an uncoated region 12a, respectively. The coated regions of the positive and negative electrodes 11 and 12 may be a region of a current collector, which is coated with an active material. Here, the current collector may be formed of a thin plate metal foil. The uncoated regions 11a and 12a may be a region of the current collector, which is not coated with an active material.

The uncoated region 11a of the positive electrode 11 may be formed at one end of the positive electrode 11 and extend along a length direction of the positive electrode 11. The uncoated region 12a of the negative electrode 12 may be formed at the other end of the negative electrode 12 and extend along a length direction of the negative electrode 12. The positive electrode 11 and the negative electrode 12 may be spiral-wound with the separator 13 positioned therebetween. The separator 13 may be an insulator.

The present invention, however, is not limited to the structure described above. The electrode assembly 10 may be formed as a stacking structure by stacking a positive electrode and a negative electrode, which are formed of a plurality of sheets, with a separator positioned therebetween.

The case 21 may be formed of metal and may generally have a hexahedral shape. The case 21 may include an opening at one side thereof. The cap assembly 30 may include a cap plate 31 coupled at an opening of the case 21, a positive electrode terminal 41 protruding toward the outside of the cap plate 31 and electrically connected to the positive electrode 11, a negative electrode terminal 42 protruding toward the outside of the cap plate 31 and electrically connected to the negative electrode 12, and a vent member 39 having a notch 39a that can be broken by an internal pressure (e.g., a predetermined internal pressure).

The cap plate 31 may be formed of a thin plate. The cap plate 31 may include an electrolyte injection opening 31a for injecting electrolyte solution and a sealing cap 38 for sealing the electrolyte injection opening 31a. The electrolyte injection opening 31a may be formed at one side of the cap plate 31 and the sealing cap 38 may be fixedly installed at the cap plate 31.

A positive current collecting tap 32 may have a lower part connected to the positive electrode uncoated region 11a through welding and an upper part fixed at the positive electrode terminal column 34 through welding. A lower insulating member 26 may be disposed under the cap plate 31 in order to insert the positive electrode terminal column 34 and the positive current collecting tap 32.

A flange member 34a may be formed at one end of the positive electrode terminal column 34. The flange member 34a may contact the positive current collecting tap 32. A column member 34b may be formed at the other end of the positive electrode terminal column 34 and inserted at the positive electrode terminal 41. A protrusion 34c may be formed at a bottom of the flange member 34a. The protrusion 34c may be inserted at the positive current collecting tap 32 and fixed through welding.

The top and bottom of the positive electrode terminal column 34 may be pressed (and/or compressed/deformed) after being inserted through the cap plate 31 and the positive electrode terminal 41. Accordingly, the positive electrode terminal column 34 may be fixed at the cap plate 31 and the positive electrode terminal 41.

Particularly, the top of the positive electrode terminal column 34 is pressed (and/or compressed/deformed) and spread out on a surface of the positive electrode terminal 41. Accordingly, the positive electrode terminal column 34 is fixed at the positive electrode terminal 41.

A first gasket 28 may be disposed between the positive electrode terminal column 34 and the cap plate 31 for insulation. A second gasket 29 may be disposed between the positive electrode terminal 41 and the cap plate 31 for insulation.

The negative current collecting tap 33 may have a lower part connected to the negative electrode uncoated region 12a through welding and an upper part fixed at the negative electrode terminal column 35 through welding. A lower insulating member 26 may be disposed in the case 21 under the cap plate 31. The negative electrode terminal column 35 and the negative current collecting tap 33 may be inserted in the lower insulating member 26.

A flange member 35a may be formed at one end of the negative electrode terminal column 35. The flange member 35a may contact the negative electrode current collecting tap 33. A column member 35b may be formed at the other end of the negative electrode terminal column 35 and inserted at the negative electrode terminal 42. A protrusion 35c may be formed at a bottom of the flange member 35a. The protrusion 35c may be inserted at the negative current collecting tap 33 and fixed through welding.

The top and bottom of the negative electrode terminal column 35 may be pressed (and/or compressed/deformed) after being inserted through the cap plate 31 and the negative terminal 42. Accordingly, the negative electrode terminal column 35 may be fixed at the cap plate 31 and the negative terminal 42. Particularly, the top of the negative electrode terminal column 35 may be pressed (and/or compressed/deformed) and extended outwardly. Accordingly, the negative electrode terminal column 35 may be fixed at the negative electrode terminal 42.

A first gasket 28 may be disposed between the negative electrode terminal column 35 and the cap plate 31 for insulation. A second gasket 29 may be disposed between the positive electrode terminal 41 and the cap plate 31 for insulation.

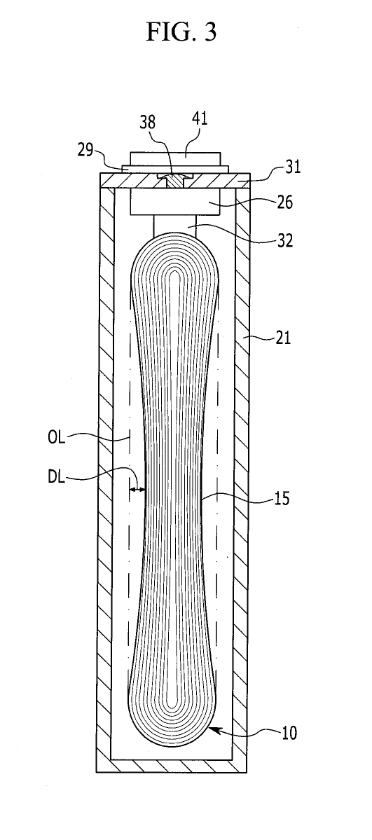

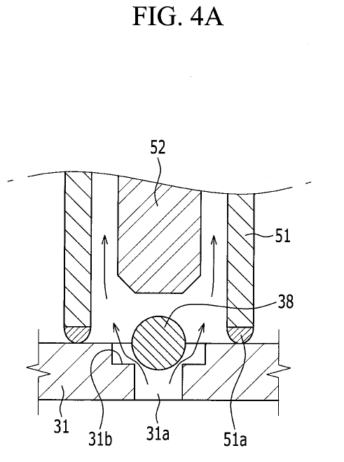

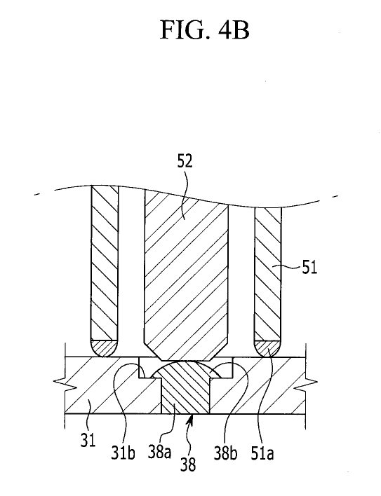

FIG. 3 is a cross-sectional view of FIG. 1 taken along the line III-III. FIG. 4A illustrates forming a negative pressure inside a case. FIG. 4B illustrates disposing a sealing cap at an electrolyte injection opening.

Referring to FIGS. 3, 4A and 4B, the cap plate 31 may include an electrolyte injection opening 31a for injecting electrolyte solution. The electrolyte injection opening 31a may penetrate the cap plate 31 and a groove 31b may be formed at an upper part of the electrolyte injection opening 31a. The groove 31b may have a cross-section wider than that of the electrolyte injection opening 31a.

A ball shaped sealing cap 38 may be inserted and disposed in the groove 31b and a pipe-shaped negative pressure forming member 51 is disposed at the outside of the electrolyte injection opening 31a and surrounds a periphery (e.g., a circumference) of the electrolyte injection opening 31a. A pressing member 52 may be disposed inside the negative pressure forming member 51. The pressing member 52 may be used to press (and/or compress) the sealing cap 38. Since the pressing member 52 is disposed inside the negative pressure forming member 51, the negative pressure forming member 51 draws in gas and the pressing member 52 concurrently inserts (e.g., by exerting pressure) the sealing cap 38 into the electrolyte injection opening 31a. Accordingly, the negative pressure forming member 51 can form negative pressure inside the case 21.

When the negative pressure forming member 51 draws in gas from inside the case 21, an internal pressure of the case 21 becomes a negative pressure lower than the atmospheric pressure. Here, the difference between the atmospheric pressure and the internal pressure of the case 21 may be greater than about 45 kPa. The negative pressure forming member 51 may be formed in a pipe shape, the sealing member 51a may be disposed at a lower end of the negative pressure forming member 51, and the sealing member 51a may have elastic force. The negative pressure forming member 51 may be connected to a vacuum pump for discharging (or extracting) gas from inside the case 21.

In accordance with the first exemplary embodiment of the present invention, a method of manufacturing the rechargeable battery 101 may include injecting electrolyte solution inside the case 21 for internally housing the electrode assembly 10; disposing the sealing cap 38 at the electrolyte injection opening 31a; forming a negative pressure by drawing in (or extracting) gas from inside the case 21 using the negative pressure forming member 51 connected to a cap plate; and inserting and disposing the sealing cap 38 inside the electrolyte injection opening 31a by pressing (e.g., exerting pressure on) the sealing cap 38 installed inside the negative pressure forming member 51.

In the forming a negative pressure, gas inside the case 21 is drawn in (and exhausted from inside of the case 21) through the electrolyte injection opening 31a after disposing the pipe shaped negative pressure forming member 51 to surround the periphery (e.g., circumference) of the electrolyte injection opening 31a from the outside of the electrolyte injection opening 31a. In the forming a negative pressure, the gas inside the case 21 may be discharged (e.g., exhausted or released) to make a difference between the internal pressure of the case 21 and the atmospheric pressure higher than about 45 kPa.

In the inserting and installing a sealing cap 38, the sealing cap 38 is pressed while gas is being released using the negative pressure forming member 51 coupled to the cap plate 31.

The pressing member 52 presses (and/or compresses) and inserts the sealing cap 38 into the electrolyte injection opening 31a after the negative pressure forming member 51 forms a negative pressure inside the case 21. Accordingly, the negative pressure may be formed inside the case 21 while installing the sealing cap 38.

Also, the sealing cap 38 is compressed or deformed as the pressurizing member 52 exerts pressure on the sealing cap 38. The sealing cap 38 may have a sealing rod 38a inserted into the electrolyte injection opening 31a and a head member 38b formed at an upper part of the sealing cap 38. The head member 38b may have a width cross-section greater than the sealing rod 38a and be inserted into a groove 31b formed on the electrolyte injection opening 31a. The sealing cap 38 may be made of metal or polymer material, but the present invention is not limited thereto.

In accordance with the present exemplary embodiment, as shown in FIG. 3, the electrode assembly 10 may be pressed or/or compressed. Outer sides of the electrode assembly 10 may be concaved inwardly in a thickness direction. Accordingly, the electrode assembly 10 may include a curved member (e.g., curvature or a curved surface) 15 at the outer side thereof. When the rechargeable battery 101 is placed in an upright orientation so the terminals 41 and 42 are located at the top of the rechargeable battery 101, an outer side of the electrode assembly 10 may be separated from a line (OL) connecting a top end and a bottom end of the electrode assembly 10 at a center part of the electrode assembly 10 in a height direction and disposed toward a center part of the electrode assembly 10 in a width direction. The outer side of the electrode assembly 10 may be separated from the line OL by a certain distance (DL). Particularly, a distance between the outer side of the electrode assembly 10 and the OL line may gradually increase as it approaches from a top and a bottom of the electrode assembly 10 to the center of the electrode assembly 10 in a height direction. Here, the OL line is a line connecting the top of the electrode assembly 10 to the bottom of the electrode assembly 10. In other words, an outer side (or outer surface) of the electrode assembly 10 at a center part in a height direction of the electrode assembly is separated from a tangent line OL in the height direction from a surface near a top end of the electrode assembly 10 to a surface near a bottom end of the electrode assembly 10, and is disposed toward the center of the electrode assembly from the line by the distance DL.

When the rechargeable battery 101 is placed in an upright orientation so the terminals 41 and 42 are located at the top of the rechargeable battery 101, a gap between the positive electrode 11 and the negative electrode 12 at a center part of the electrode assembly 10 in a height direction may be less than a gap between the positive electrode 11 and the negative electrode 12 at both ends of the electrode assembly 10 in a height direction. For example, a gap between the positive electrode 11 and the negative electrode 12 may become gradually reduced as it approaches from the both ends of the electrode assembly 10 toward the center of the electrode assembly 10 in a height direction.

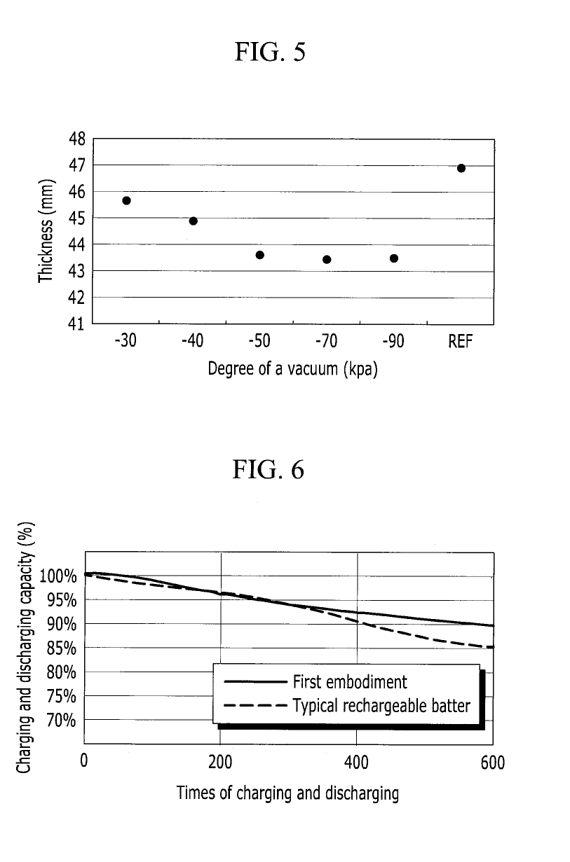

FIG. 5 is a graph showing changes in a thickness of an electrode assembly 10 according to an internal pressure of a case 21. As shown, the thickness of the electrode assembly 10 is significantly reduced when the difference between the internal pressure of the case 21 and the atmospheric pressure is greater than about 45 kPa. The graph of FIG. 5 shows results of experiment that is performed using a jelly-roll type rectangular rechargeable battery having a capacity of about 63 Ah.

It is desirable to increase or maximize the difference between the negative pressure of the case 21 and the atmospheric pressure as long as the case is capable of enduring or withstanding the negative pressure applied to the case 21. Accordingly, an upper limit of the difference between the negative pressure inside the case 21 and the atmospheric pressure is not defined herein.

When a gap between the positive electrode 11 and the negative electrode 12 is relatively wide, a migration length of ions becomes relatively longer. Accordingly, charging and discharging efficiency may become deteriorated. In order to solve such a problem, a spacer supporting the electrode assembly 10 may be disposed between the case 21 and the electrode assembly 10. In this case, an overall weight of a corresponding battery may be increased and it may cause a swelling problem. When the electrode assembly 10 expands due to the swelling problem, the spacer may press the electrode assembly 10. As a result, deterioration may quickly progress and a cycle-life (e.g., a life time of the battery) may be shortened. In accordance with the present exemplary embodiment, a negative pressure that is lower than the atmospheric pressure may be formed as the internal pressure of the case 21. Accordingly, a gap between the positive electrode 11 and the negative electrode 12 may be reduced without implementing an additional spacer.

Furthermore, gas may be generated inside the rechargeable battery 101 due to decomposition of electrolyte solution while the rechargeable battery 101 is repeatedly charged and discharged. Such gas generation may increase the internal pressure of the rechargeable battery 101. In this case, the electrode assembly 10 expands and charging and discharging efficiency may become deteriorated. As a result, the cycle-life of the electrode assembly 10 may be shortened. In accordance with the present exemplary embodiment, the internal pressure of the case 21 may be initially formed as a negative pressure. Accordingly, the cycle-life (e.g., a life time) of the rechargeable battery 101 may be improved.

FIG. 6 is a graph showing that a speed of reduction in cycle-life (e.g., a life time) of the rechargeable battery according to the present exemplary embodiment is significantly lower than that of a typical rechargeable battery based on 600 cycles.

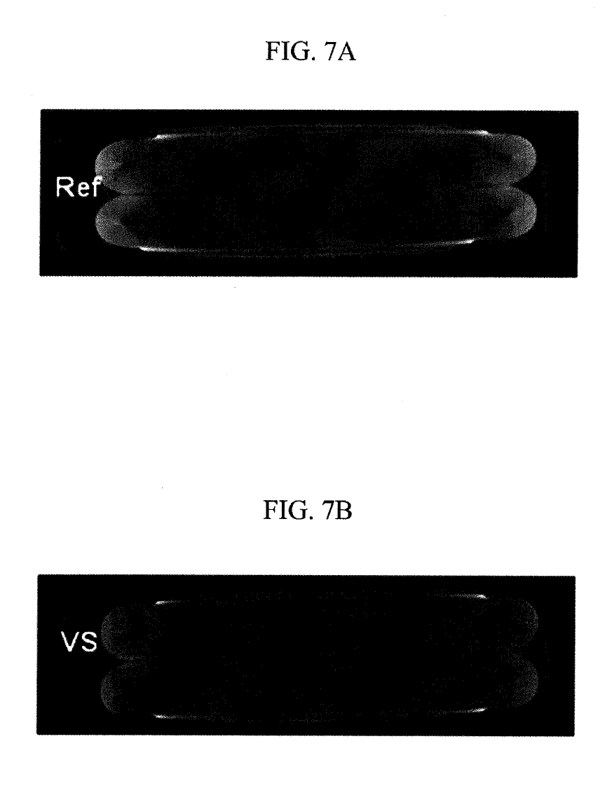

FIG. 7A is a photograph that shows an inside of a typical rechargeable battery.

FIG. 7B is a photograph that shows an inside of a rechargeable battery in accordance with the present exemplary embodiment.

As shown in FIG. 7A and FIG. 7B, an interfacing surface of a center part of the electrode assembly 10 in a width direction may be prevented from bending because the rechargeable battery 101 according to the present exemplary embodiment forms a negative pressure inside the case 21. Accordingly, the interfacing surface may not become non-uniform. When the interfacing surface is non-uniform, the migration distance of ions becomes comparatively (or relatively) longer. Accordingly, charging and discharging efficiency may be deteriorated. Such a problem may be prevented in accordance with the present exemplary embodiment. In order to prevent the interfacing surface from being non-uniform, a core may be inserted at a center of the electrode assembly 10. When the core is inserted at the center of the electrode assembly 10, the weight of the rechargeable battery 101 is increased. Furthermore, a part of the electrode assembly 10, which contacts the core when the electrode assembly 10 expands, may become quickly deteriorated.

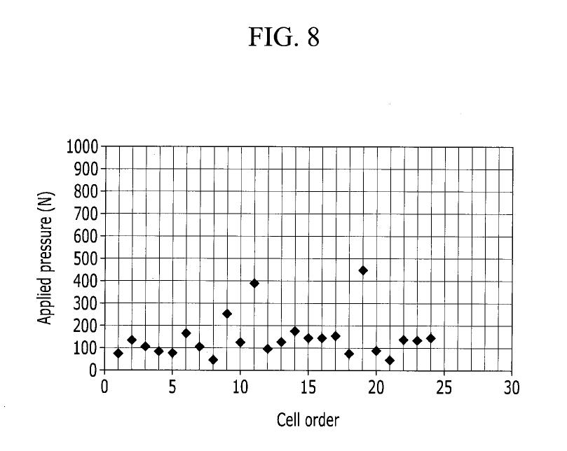

Since typical rechargeable batteries are formed to have a convex part at a center thereof, a predetermined pressure is applied in order to closely attach rechargeable batteries. For example, a maximum pressure of about 45,000 N may be applied to the rechargeable batteries. As shown in FIG. 8, since the maximum pressure applied to the rechargeable battery 101 does not exceed about 500 N in accordance with the present exemplary embodiment, the pressure applied to the rechargeable battery 101 may be significantly reduced compared to that applied to a typical rechargeable battery.

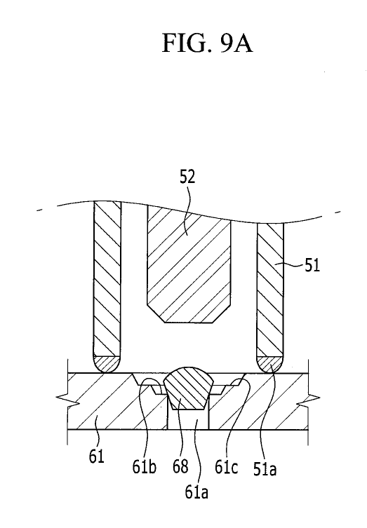

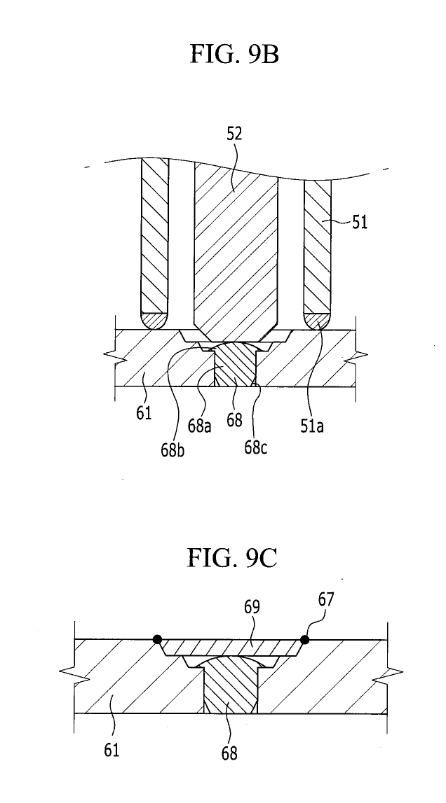

FIG. 9A illustrates forming a negative pressure inside a case of a rechargeable battery in accordance with a second exemplary embodiment of the present invention. FIG. 9B illustrates disposing a sealing cap at an electrolyte injection opening of a rechargeable battery in accordance with the second exemplary embodiment of the present invention. FIG. 9C illustrates a sealing cap disposed at an electrolyte injection opening of a rechargeable battery in accordance with the second exemplary embodiment of the present invention.

The rechargeable battery in accordance with the second exemplary embodiment may have a substantially similar configuration as the first exemplary embodiment, except for an electrolyte injection opening and a sealing cap. Accordingly, the detailed descriptions of similar elements may be omitted.

As shown in FIG. 9A, an electrolyte injection opening 61a may be formed in a cap plate 61. A first groove 61b may be formed on the electrolyte injection opening 61a. The first groove 61b may have a cross-section wider than that of the electrolyte injection opening 61a. Furthermore, a second groove 61c may be formed on the first groove 61b. The second groove 61c may have a cross-section wider than that of the first groove 61b.

The sealing cap 68 may have a shape of a truncated circular cone that has a top surface bent in a spherical shape. Accordingly, the sealing cap 68 may have a transverse section that becomes reduced in diameter as it approaches a lower end.

A pipe-shaped negative pressure forming member 51 may be disposed to surround a periphery (e.g., circumference) of the electrolyte injection opening 61a from an outer side of the second groove 61c with the sealing cap 68 partially inserted into the electrolyte injection opening 61a.

The pressing member 52 pressing (applying or exerting pressure on) the sealing cap 68 may be disposed inside the negative pressure forming member 51.

When gas is drawn in (and thereby discharged or released from the inside of the case 21) using the negative pressure forming member 51, a negative pressure that is lower than the atmospheric pressure may be formed inside the case 21. The negative pressure forming member 51 may be formed in a pipe shape. A sealing member having an elastic power may be disposed at a lower end of the negative pressure forming member 51. The negative pressure forming member 51 may be connected to a vacuum pump in order to discharge (or exhaust) gas from the inside of the case 21.

As shown in FIG. 9B, the pressing member 52 may press (and/or compress) and push the sealing cap 68 into the electrolyte injection opening 61a after the negative pressure forming member 51 forms the negative pressure inside the case. Accordingly, the sealing cap 68 may be deformed. The sealing cap 68 may include a sealing rod 68a inserted into the electrolyte injection opening 61a, a head member 68b formed at an upper end of the sealing rod 68a, and a guiding member 68c formed at a lower end of the sealing rod 68a. The guiding member 68c may have a cross-section that is reduced as the lower end is approached. Due to the guiding member 68c of the sealing cap 68 in accordance with the present exemplary embodiment, the sealing cap 68 may be further easily inserted into the electrolyte injection opening 61a. In case of using a ball-shaped sealing cap to seal the electrolyte injection opening 61a, the ball-shaped sealing cap may be not stably inserted into the electrolyte injection opening 61a when a direction of applying pressure is improper. In accordance with the present exemplary embodiment, a pressure is applied after the guiding member 68c is inserted into the electrolyte injection opening 61a. Accordingly, the electrolyte injection opening 61a may be further stably sealed.

As shown in FIG. 9C, a sealing cover 69, formed in a plate shape, may be inserted and disposed at the second groove 61c after the sealing cap 68 is disposed. The sealing cover 69 may be fixed at the cap plate 61 through welding. Accordingly, a welding member 67 may be formed on a top surface where the sealing cover 69 meets the cap plate 61. The sealing cover 69 may be fixed through welding at a corner where an upper end of the second groove 61c meets a top surface of the cap plate 61.

Accordingly, the electrolyte injection opening 61a may be further stably sealed because the electrolyte injection opening 61a may be sealed doubly. When electrolyte solution is injected, surroundings of the electrolyte injection opening 61a may be contaminated. Thus, the top surface of the first groove 61b may be contaminated. However, the second groove 61c may be not contaminated because the second groove 61c is formed higher and wider than the first groove 61b. Accordingly, it may prevent sealing performance from being deteriorated which may be caused by perform welding at a contaminated region.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims and their equivalents.

Description of Some of the Reference Numerals

| | |
|---|---|
| 101: rechargeable battery | 10: electrode assembly |
| 11: positive electrode | 11a: positive electrode uncoated |
| | region |
| 12: negative electrode | 12a: negative electrode uncoated |
| | region |
| 13: separator | 15: curved member (or curved |
| | surface) |
| 21: case | 26: lower insulating member |
| 28: first gasket | 29: second gasket |
| 30: cap assembly | 31, 61: cap plate |
| 31a, 61a: electrolyte injection opening | 31b: groove |
| 32: positive current collecting tap | 33: negative current collecting |
| | tap |
| 34: positive electrode terminal column | 34a, 35a: flange member |
| 34b, 35b: column member | 34c, 35c: protrusion |
| 35: negative electrode terminal column | 38, 68: sealing cap |
| 38a, 68a: sealing rod | 38b, 68b: head member |
| 39: vent member | 39a: notch |
| 41: positive terminal | 42: negative terminal |
| 51: negative pressure forming member | 51a: sealing member |
| 52: pressing member | 61b: first groove |
| 61c: second groove | 67: welding member |
| 68c: guiding member | 69: sealing cover |

What is claimed is:

1. A rechargeable battery comprising:
an electrode assembly comprising a positive electrode and a negative electrode;
a case housing the electrode assembly; and
a terminal electrically coupled to the electrode assembly and protruding to an outside of the case,
wherein an internal pressure of the case is lower than an atmospheric pressure.

2. The rechargeable battery of claim 1, wherein a difference between the internal pressure of the case and the atmospheric pressure is greater than about 45 kPa.

3. The rechargeable battery of claim 1, wherein the electrode assembly has a curved outer surface, and the curved outer surface is concave toward an inside of the electrode assembly in a thickness direction of the electrode assembly.

4. The rechargeable battery of claim 1, wherein a distance between the positive electrode and the negative electrode at a center part in a height direction of the electrode assembly is less than distances between the positive electrode and the negative electrode at both ends in the height direction of the electrode assembly.

5. The rechargeable battery of claim 4, wherein a distance between the positive electrode and the negative electrode is gradually reduced as a center part of the electrode assembly is approached from the both ends in the height direction of the electrode assembly.

6. The rechargeable battery of claim 1, wherein an outer side of the electrode assembly at a center part in a height direction of the electrode assembly is separated from a tangent line in the height direction from a surface near a top end of the electrode assembly to a surface near a bottom end of the electrode assembly, and is disposed toward the center of the electrode assembly.

7. The rechargeable battery of claim 6, wherein a distance from the outer side of the electrode assembly to the tangent line gradually increases as a center is approached in the height direction from the top end and the bottom end.

8. The rechargeable battery of claim 1, wherein the sealing cap comprises a column member in an electrolyte injection opening and a flange member at a top end of the column member and in a first groove on the electrolyte injection opening.

9. The rechargeable battery of claim 8, wherein a guiding member is at a bottom end of the column member, and the guiding member has a cross-section that is reduced as the bottom end of the column member is approached.

10. The rechargeable battery of claim 8, wherein a second groove is on the first groove, the second groove is wider than the first groove, a sealing cover is in the second groove, and the sealing cover is fixed at a cap plate through welding.

11. A method for manufacturing a rechargeable battery, the method comprising:
injecting an electrolyte solution into a case housing an electrode assembly through an electrolyte injection opening in a cap plate coupled to the case;
disposing a sealing cap at the electrolyte injection opening;
forming a negative pressure inside the case by discharging gas from the case through the electrolyte injection opening using a negative pressure forming member that is disposed at the cap plate; and
inserting the sealing cap in the electrolyte injection opening and installing the sealing cap at the electrolyte injection opening by pressing the sealing cap using the negative pressure forming member after the negative pressure forming member is coupled to the cap plate.

12. The method of claim 11, wherein in the forming the negative pressure, a difference between an internal pressure of the case and an atmospheric pressure is greater than about 45 kPa.

13. The method of claim 11, wherein in the forming the negative pressure, the negative pressure forming member is pipe-shaped and surrounds a periphery of the electrolyte injection opening from an outer side of the electrolyte injection opening, and gas is discharged from the case.
